(19) United States
(12) Patent Application Publication
(10) Pub. No.: US 2006/0029224 A1
(43) Pub. Date: Feb. 9, 2006

(54) System and recording medium for securing data and methods thereof

(76) Inventors: Yoo-Jin Baek, Seongnam-si (KR); Sang-geun Oh, Seongnam-si (KR); Seo-kyu Kim, Seoul (KR)

Correspondence Address: HARNESS, DICKEY & PIERCE, P.L.C., P.O. BOX 8910, RESTON, VA, 20195, US

(21) Appl. No.: 11/197,316

(22) Filed: Aug. 5, 2005

(30) Foreign Application Priority Data
Aug. 6, 2004 (KR) 10-2004-0061956

(51) Int. Cl. H04L 9/30

(52) U.S. Cl. 380/30

(57) ABSTRACT

A system and recording medium for securing data and methods thereof including a modular exponentiation. One embodiment includes first masking a message, second masking an exponent, and executing a modular exponentiation based at least one of the first and second maskings. Another embodiment includes first masking a message, second masking at least one exponent, executing a modular exponentiation based at least one of the first and second maskings, detecting an error, executing a modular multiplication operation based on the detection and diffusing the detected error to generate an electronic signature. Yet another embodiment includes first masking a message, second masking at least one exponent, executing a modular exponentiation based at least one of the first and second maskings, detecting an error, and generating an electronic signature based on the detected error.

### PRIORITY STATEMENT

This application claims the priority of Korean Patent Application No. 2004-61956, filed on Aug. 6, 2004, in the Korean Intellectual Property Office, the disclosure of which is incorporated herein in its entirety by reference.

### BACKGROUND OF THE INVENTION

1. Field of the Invention

The present invention relates generally to a system and recording medium and methods thereof, and more particularly to a system and recording medium for securing data and methods thereof.

2. Description of the Related Art

Securing information may require encryption (e.g., encryption algorithms and/or encryption protocols). Secret key encryption algorithms are one method of securing information. However, secret key encryption algorithms may suffer from key distribution and/or electronic signature problems.

Public key encryption algorithms may reduce problems (e.g., key distribution and electronic signature problems) associated with information security (e.g., internet, financial networks, etc.). The Rivest Shamir Adleman (RSA) algorithm is one example of a public key algorithm. The RSA algorithm may execute encryption, decryption, generation and/or authentication of an electronic signature as described below with respect to communication between first and second users.

A first user may generate two large prime numbers p and q and may compute n=(p*q) and φ(n)=(p−1)*(q−1). The first user may select an integer e that may be relatively prime to φ(n) and an integer d that may satisfy Equation 1 as given below. Relative prime means that two natural numbers have only one common divider. For example, 8 and 9 are relatively prime because 8 has dividers 1, 2 and 4 and 9 has dividers 1, 3, and 9. Thus, 8 and 9 share only one common divider, i.e, “1”.
ed=1 mod φ(n) Equation 1

Equation 1 illustrates that the remainder obtained when ed is divided by φ(n) may be 1. Numbers (n, e) may be available to the public as a public key of the first user, and numbers (p, q, d) may be used as a secret key of for the first user.

The second user may transmit a message M and a cryptogram C to the user. The cryptogram C may be extracted by the first user by executing a modular exponentiation operation, as given by
C=M^{e} mod n Equation 2
using the public key (n, e) of the first user.

The first user may execute a modular exponentiation operation, represented below by Equation 3, using the secret key d to recover the original message M.
M=C^{d} mod n Equation 3

The first user may electronically sign the message M with another modular exponentiation operation, as given by
S=M^{d} mod n
using the secret key d to generate an electronic signature S for the message M.

The second user may receive the electronic signature S for the message M and may verify (e.g., authenticate) that the electronic signature S is generated by the first user by executing a modular exponentiation operation, as given by
M′=S^{e} mod n
using the public key (n, e) of the first user to compute M′.

The second user may verify second that S is the electronic signature for M, generated by the first user, by comparing M′ with M.

The problem of determining the secret key (p, q, d) based on the public key (n, e) in the RSA public key cryptosystem may relate to the problem of determining prime factors (p, q) based on n. By conventional methods, n may be set to at least 1024 bits. However, a higher amount of processing power may be required to execute a modular exponentiation when n is set to a higher bit level (e.g., at least 1024 bits).

Another conventional modular exponentiation based on a Chinese remainder theorem (CRT) may increase an operation speed of executing a modular exponentiation as compared to conventional methods not including the CRT.

The CRT may include an integer x (hereinafter represented as CRT(x₁, x₂, . . . . xₖ)) which may satisfy a modular equation represented below by Equation 6. Equation 6 may include positive integers p₁, p₂, and . . . pₖ, which may be relatively prime, and integers x1, x₂ . . . and xₖ.
x=x₁ mod p₁, x=x₂ mod p₂, . . . . , x=xₖ mod pₖ Equation 6

A conventional method of executing an RSA decryption operation and an electronic signature generating operation including the CRT will now be explained.

A first user may compute dp, dq, pi and qi, which may satisfy Equation 7, using a secret key (p, q, d) as given by
dp=d mod (p−1), dq=d mod (q−1), pi=p⁻¹ mod q, qi=q⁻¹ mod pq Equation 7

The first user may compute Sp as given below by Equation 8 to generate an electronic signature S for M. The CRT may ensure that S may be an electronic signature for M.
Sp=M^{dp} mod p, Sq=M^{dq} mod q,
S=CRT(Sp, Sq)=(q*qi*Sp+p*pi*Sq)mod n Equation 8

The above-described conventional RSA public key cryptosystem and RSA public key cryptosystem based on the CRT may not be secure against a side channel attack and/or a fault attack. The side channel attack may refer to the extracting of secret information through a side channel during an encryption operation. The side channel attack may include a timing attack and/or a power attack.

The timing attack may be an extraction of either a secret key or the hamming weight of the secret key. The hamming weight of the secret key may correspond to the number of bits at a first logic level (e.g., a high logic level, a low logic level, etc) when the secret key is a binary number. For example, the number twelve (12) may have a hamming weight of two (2) since a corresponding binary number may be “1100” which includes two 1s (e.g., bits with a high logic level).

The timing attack may include a consideration of various factors. One factor for consideration may be that a period of time required for executing a squaring operation and a period of time required for executing a multiplication operation in a modular exponentiation algorithm may be different. Another factor for consideration may be that the squaring operation may be executed when a bit value of an exponent is at a second logic level (e.g., a low logic level) and both the squaring and multiplication operations may be executed when the bit value is at the first logic level (e.g., a high logic level). Another factor for consideration may be that a modular exponentiation execution time may vary in response to a message.

Conventional methods of reducing the timing attack may include inserting a “dummy” operation to ensure a uniform execution time irrespective of a bit value of an exponent, a method of masking an exponent, and a method of masking a message. However, inserting a dummy operation may require a higher processing speed.

The power attack may include a simple power attack and/or a differential power attack. Power consumed by a cryptosystem may be based on a state of an internal register. The power attack may analyze the power consumption of the cryptosystem in order to extract a secret key.

The fault attack may include causing a computational error in a device executing an encryption operation. The device may output an erroneous result (e.g., due to the inserted error). The erroneous result may be analyzed in order to extract secret information stored in the device. The fault attack may include a simple fault attack and/or a differential fault attack.

The simple fault attack may include deriving the secret key based on an analysis of the erroneous result. The erroneous result may include an error introduced into only one of the intermediate results Sp and Sq of the decryption process and/or into an electronic signature generated by the CRT-based RSA cryptosystem. The simple fault attack may not impose restrictions on the cause of the generation of the error and may render the CRT-based RSA public key cryptosystem vulnerable.

One conventional safeguard against the simple fault attack may include inserting a result confirming step. Inserting the result confirming step may require a condition checking command. However, the condition checking command may be vulnerable to the side channel attack. Further, inserting the result confirming step may include a probability that an error may not be detected. The probability may correspond to 1/r, r being a random number.

The differential fault attack may extract the secret key when one bit of a register storing the intermediate result of the modular exponentiation of the RSA cryptosystem may be inverted. The differential fault attack may require a higher level of processing and/or a higher data capacity as compared to the simple fault attack. The differential fault attack may confirm the position of the inverted bit generated during the attack.

### SUMMARY OF THE INVENTION

Example embodiments of the present invention are directed to a computer program product, system and method of securing data, including first masking a message M using a number n and a random number r that is relatively prime to a number n, second masking an exponent d using the number n and a random number x that is relatively prime to φ(n) and executing a modular exponentiation based on data obtained from the first and second maskings.

Other example embodiments of the present invention are directed to a computer program product, system and method of securing data, including first masking a message M, second masking exponents dp and dq, first executing a modular exponentiation based on the first and second maskings, detecting an error using modular exponentiation data obtained from the first execution, second executing a modular multiplication operation based on the detection and diffusing the detected error to generate a first signature S.

Other example embodiments of the present invention are directed to a computer program product, system and method of securing data, including first masking a message M using numbers n, p, q, e and a random number r that is relatively prime to a number n, numbers n and p being prime numbers, second masking exponents dp and dq using (p−1), (q−1), and the random number r that is relatively prime to φ(n), executing a modular exponentiation based on data obtained by the first and second maskings, detecting an error included in the output data of the modular exponentiation and generating a signature S including the detected error.

Other example embodiments of the present invention are directed to a computer program product, system and method of securing data, including first masking a message, second masking at least one exponent and first executing a modular exponentiation based on at least one of the first masking and the second masking.

### BRIEF DESCRIPTION OF THE DRAWINGS

The present invention will become more apparent by describing in detail example embodiments thereof with reference to the attached drawings in which:

FIG. 1 illustrates a flow chart of a first modular exponentiation algorithm 100 according to another example embodiment of the present invention.

FIG. 2 illustrates a flow chart of a second modular exponentiation algorithm 200 according to another example embodiment of the present invention.

FIG. 3 illustrates a flow chart of a third modular exponentiation algorithm 300 according to another example embodiment of the present invention.

### DETAILED DESCRIPTION OF THE EXAMPLE EMBODIMENTS OF THE PRESENT INVENTION

Hereinafter, example embodiments of the present invention will be described in detail with reference to the accompanying drawings.

In an example embodiment of the present invention, modular exponentiation for computing M^{e} mod n and M^{d} mod n may be executed.

In another example embodiment of the present invention, M^{e} mod n and M^{d} mod n may be calculated by Algorithm I as given by
Input: M, d=(dₜdₜ₋₁ . . . d₀)₂, n
Output: M^{d} mod n
   1. S=1, T=M
   2. For i from 0 to t
      If dᵢ=1 then
         S=S*T mod n
         T=T² mod n
   3. Return S Algorithm I
      where Algorithm I may compute from the Least Significant Bit (LSB) of an exponent to the Most Significant Bit (MSB) (e.g., Right to Left binary exponentiation).

In another example embodiment of the present invention, M^{e} mod n and M^{d} mod n may be calculated by Algorithm II as given by
Input: M, d=(dtdt−1 . . . d0)2, n
Output: M^{d} mod n
   1. S=1
   2. For i from t to 0
      S=S² mod n
      If dᵢ=1 then
         S=S*M mod n
   3. Return S
      where Algorithm II may compute from the MSB of an exponent to the LSB (e.g., Left to Right binary exponentiation).

In another example embodiment of the present invention, referring to the For loop of Algorithm II, the variable i may be count from t (MSB) to 0 (LSB) by a given increment (e.g., 1). When the value of the exponent dᵢ, which may correspond to the variable i, is zero (0), S=S² mod n may be computed. This operation may be repeated until the For loop completes execution. When the exponent dᵢ designated by the variable i (e.g., for each iteration of the For loop) is at a first logic level (e.g., a high logic level) is met, S=S*M may be computed for each iteration of the For loop. Thus, two operations may be executed by Algorithm II when the value of the exponent dᵢ designated by the variable i is 1 (e.g., for the two remaining iterations of the For loop).

In another example embodiment of the present invention, when the exponent d is 13 (e.g., in decimal notation), the exponent d may be represented by “1101” (e.g., in binary notation). Thus, d₃, d₂, d₁ and d₀ may be “1”, “1”, “0” and “1”, respectively. When i is 3, S may be set to the first logic level irrespective of the value of n when the operation (S=S² mod n) may be executed because S may equal 1. Since d₃ may be 1, the conditional statement may be satisfied. A value M (e.g., equal to S*M) may be stored in S that previously stored the initial value “1” (e.g., S=M). S may equal M when i equals 2. Thus, S may be set to M² when the operation (S=S² mod n) may be executed. The conditional statement may be satisfied because d₂ equals 1, and M³ (e.g., the result of the operation S*M) may be stored in S (S=M³).

S may be M³ when i equals 1 (t=1). Thus, S may be set to M⁶ when the operation S=S² mod n is executed. The conditional statement may not be satisfied because d₁ may equal 0, and M⁶ may be stored in S. S may bet set to M⁶ when i equals 0 (t=0). Thus, S may be set to M¹² when the operation (S=S² mod n) may be executed. Since d₀ may equal 1, M¹³ may be stored in S (S=M¹³) when the operation (S*M) may be executed.

In another example embodiment of the present invention, the operation including the exponent d (e.g., where d may equal 13 in decimal notation) may be inversely computed (e.g., with any of the above described algorithms).

In another example embodiment of the present invention, characteristics (e.g., a period of execution, safety against side channel attacks, etc.) associated with an execution of one of the above described algorithms (e.g., algorithm I and/or algorithm II) may vary based on whether both squaring and multiplication operations may be executed or whether only a squaring operation may be executed.

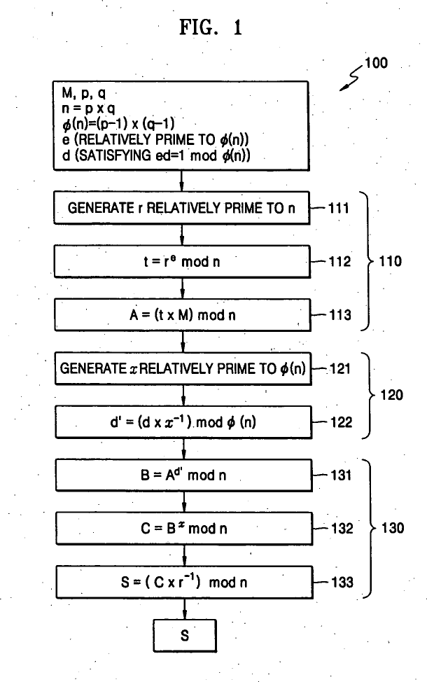

FIG. 1 illustrates a flow chart of a first modular exponentiation algorithm 100 according to another example embodiment of the present invention.

In another example embodiment of the present invention, referring to FIG. 1, the first modular exponentiation algorithm 100 may include a message masking 110, an exponent masking 120, and/or a modular exponentiation 130.

In another example embodiment of the present invention, the first modular exponentiation algorithm 100 may generate S which may satisfy (S=M^{d} mod n).

In another example embodiment of the present invention, the message M may be transmitted in secret, the number n may be obtained by multiplying two large prime numbers p and q (e.g., acquired by any well-known random prime number generator), e that is relatively prime to φ(n)(=(p−1)*(q−1)), and d satisfying ed=1 mod φ(n).

The message masking 110 may include generating a random number r that is relatively prime to n (at 111 in FIG. 1), computing t satisfying t=r^{e} mod n (at 112), and computing a masked message A satisfying A=t*M mod n (at 113).

The exponent masking 120 may include generating an integer x that is relatively prime to φ(n) (at 121) and computing a masked exponent d′ satisfying d′=d*x−1 mod φ(n) (at 122).

In another example embodiment of the present invention, the integer x may include a smaller size (e.g., approximately 30 bits). The processing requirements may be reduced by using the random number including a smaller size for the masking (e.g., the message masking and/or the exponent masking).

The modular exponentiation 130 may include computing B satisfying B=A^{d′} mod n (at 131), computing C satisfying C=Bₓ mod n (at 132), and computing S satisfying S=C*r⁻¹ mod n (at 133).

In another example embodiment of the present invention, referring to the first modular exponentiation algorithm 100 of FIG. 1, the modular exponentiation 130 may be executed for the numbers A and d′ from the message masking 110 and exponent masking 120. Thus, it may not be possible to extract data related to the secret key even if a timing attack, a power attack and/or a fault attack is attempted while the algorithm is executed. The modular exponentiation algorithm 100 may prevent or reduce extraction of the secret key through the side channel attack and/or the fault attack.

In another example embodiment of the present invention, the size of the public key e may be smaller and x may be selected as a smaller integer.

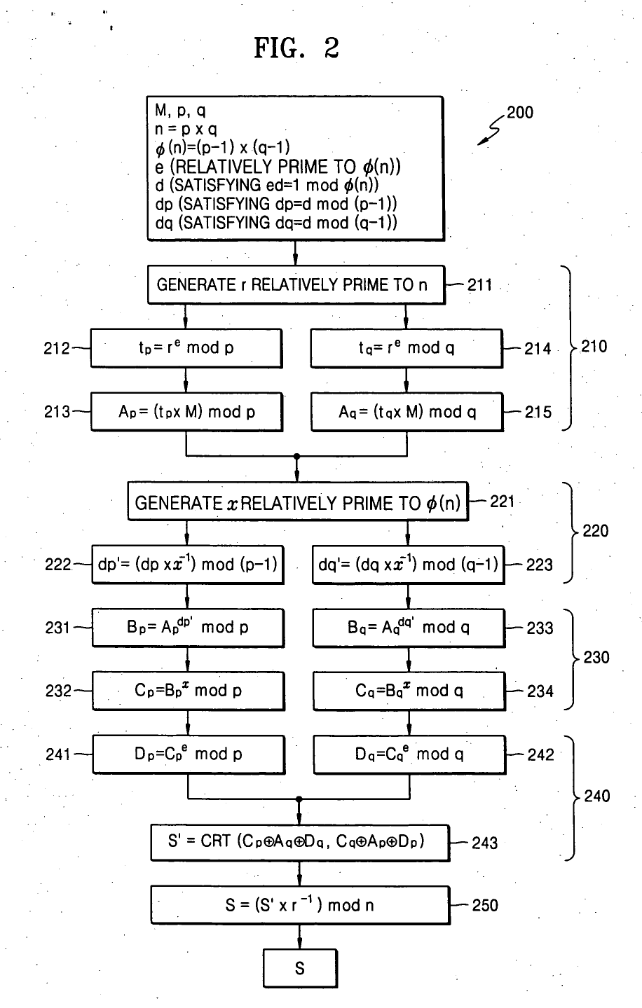

FIG. 2 illustrates a flow chart of a second modular exponentiation algorithm 200 according to another example embodiment of the present invention.

In another example embodiment of the present invention, referring to FIG. 2, the second modular exponentiation algorithm 200 may include a message masking 210, an exponent masking 220, a modular exponentiation 230, an error detection and diffusion 240, and/or a modular multiplication 250.

The second modular exponentiation algorithm 200 may receive a message M to be transmitted in secret, a number n obtained by multiplying two large prime numbers p and q, e that is relatively prime to φ(n)(=(p−1)*(q−1)), d satisfying ed=1 mod φ(n), dp satisfying dp=d mod (p−1), and/or dq satisfying dq=d mod (q−1) to generate a signature S satisfying S=M^{d} mod n.

The message masking 210 may include generating a random number r that is relatively prime to n (at 211 of FIG. 2), masking the message M using the prime number p (at 212), and masking the message M using the prime number q (at 214).

In another example embodiment of the present invention, the random number r may include a smaller number (e.g., having a size of approximately 60 bits). The processing requirements may be reduced by using the random number including the smaller size for the masking (e.g., the message making and/or the exponent masking).

In another example embodiment of the present invention, the masking of the message M using the prime number p may include computing tp=r^{e} mod p (at 212 of FIG. 2) and computing Ap=tp*M mod p (at 213).

In another example embodiment of the present invention, the masking of the message M using the prime number q may include computing tq=r^{e} mod q (at 214) and computing Ap=tq*M mod q (at 215).

In another example embodiment of the present invention, the exponent masking 220 may include generating an integer x that is relatively prime to φ(n) (at 221), masking the exponent dp using the integer x and the prime number p (at 222), and masking the exponent 0 dq using the integer x and the prime number q (at 223).

In another example embodiment of the present invention, the integer x may be a smaller number (e.g., including approximately 30 bits). The processing requirements may be reduced by using the random number including the smaller size for masking.

In another example embodiment of the present invention, the masking of the exponent dp using the integer x and the prime number p (at 222) may include computing dp′ satisfying dp′=dp*x⁻¹ mod (p−1). The masking of the exponent dq using the integer x and the prime number q (at 223) may include computing dq′ satisfying dq′=dq*x⁻¹ mod (q−1).

In another example embodiment of the present invention, the modular exponentiation 230 may include an exponentiation using the prime number p and an exponentiation using the prime number q. The exponentiation using the prime number p may include computing Bp(=Ap^{dp′} mod p) (at 231) and computing Cp(=Bpₓ mod p) (at 232). The exponentiation using the prime number q may include computing Bq(=Aq^{dq′} mod q) (at 233) and computing Cq(=Bq^{x} mod q) (at 234).

In another example embodiment of the present invention, the error detection and diffusion 240 may include computing an error variable using the prime number p (at 241), computing an error variable using the prime number q (at 242), and obtaining a diffusion variable of a detected error and applying the CRT (at 243).

In another example embodiment of the present invention, computing an error variable using the prime number p (at 241) may include computing an error variable Dp satisfying Dp=Cp^{e} mod p.

In another example embodiment of the present invention, computing an error variable using the prime number q (at 242) may include computing an error variable Dq satisfying Dq=Cq^{e} mod q.

In another example embodiment of the present invention, obtaining a diffusion variable of a detected error and applying the CRT (at 243) may include computing S′=CRT(Cp\textcircled{+}Aq\textcircled{+}Dq, Cq\textcircled{+}Ap\textcircled{+}Dp), where CRT(x₁, x₂, . . . , Xₖ) may include an integer x that satisfies x=x₁ mod p₁, x=x₂ mod p₂, . . . , x=xₖ mod pₖ based on positive integers p₁, p₂, . . . , pₖ, which may be relatively prime, and integers x₁, x₂, xₖ. Here, \textcircled{+} means Exclusive OR operation.

In another example embodiment of the present invention, the modular multiplication 250 may obtain an electronic signature S satisfying S=(S′*r⁻¹) mod n.

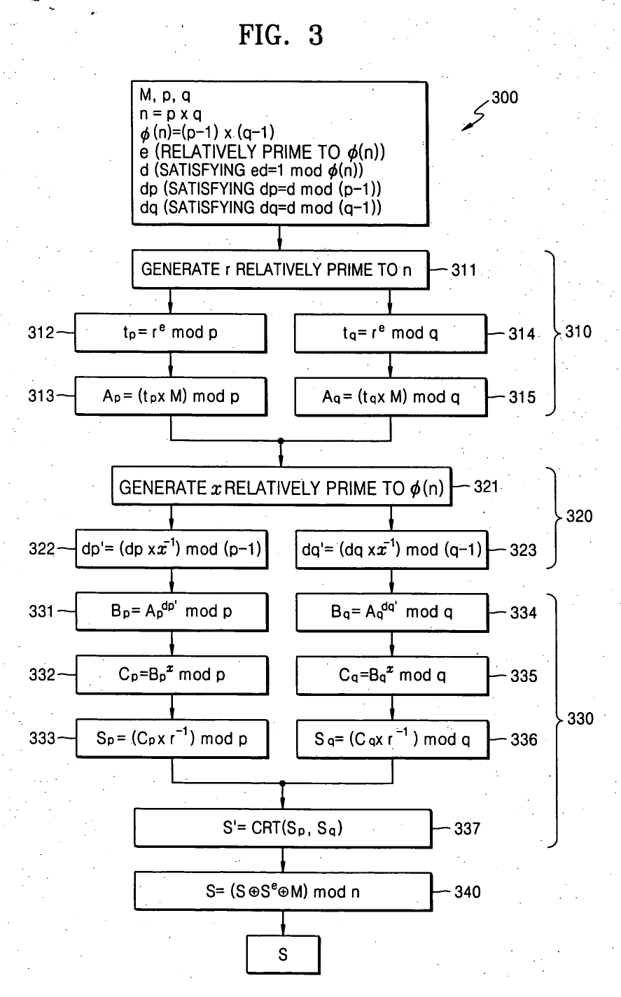

FIG. 3 illustrates a flow chart of a third modular exponentiation algorithm 300 according to another example embodiment of the present invention.

In another example embodiment of the present invention, referring to FIG. 3, the third modular exponentiation algorithm 300 may include a message masking 310, an exponent masking 320, a modular exponentiation 330, and/or an error detection 340.

The third modular exponentiation algorithm 300 may receive a message M to be transmitted in secret, a number n obtained by multiplying two large prime numbers p and q, e that is relatively prime to φ(n)(=(p−1)*(q−1)), d satisfying ed=1 mod φ(n), dp satisfying dp=d mod (p−1) and dq satisfying dq=d mod (q−1) to generate a signature S satisfying S=M^{d} mod n.

In another example embodiment of the present invention, the message masking 310 may include generating a random number r that is relatively prime to n (at 311), masking the message M using the prime number p (at 312 and 313), and masking the message M using the prime number q (at 314 and 315).

In another example embodiment of the present invention, the random number r may be smaller (e.g., including approximately 60 bits).

In another example embodiment of the present invention, the masking of the message M using the prime number p (at 312 and 313) may include computing tp=r^{e} mod p (at 312) and computing Ap=tp*M mod p (at 313).

In another example embodiment of the present invention, the masking of the message M using the prime number q (at 314 and 315) may include computing tq=r^{e} mod q (at 314) and computing Aq=tq*M mod q (at 315).

In another example embodiment of the present invention, the exponent masking 320 may include generating an integer x that is relatively prime to φ(n) (at 321), masking the exponent dp using the integer x and the prime number p (at 322), and masking the exponent dq using the integer x and the prime number q (at 323).

In another example embodiment of the present invention, the integer x may be a smaller integer (e.g., including approximately 30 bits).

In another example embodiment of the present invention, the masking of the exponent dp using the integer x and the prime number p (at 322) may compute dp′ satisfying dp′=dp*x⁻¹ mod (p−1). The masking of the exponent dq using the integer x and the prime number q (at 323) may compute dq′ satisfying dq′=dq*x⁻¹ mod (q−1).

In another example embodiment of the present invention, the modular exponentiation 330 may include an exponentiation using the prime number p (at 331, 332 and 333), an exponentiation using the prime number q (at 334, 335 and 336), and applying the CRT (at 337).

In another example embodiment of the present invention, the exponentiation using the prime number p (at 331, 332 and 333) may include computing Bp(=Ap^{dp′} mod p) (at 331), computing Cp(=Bp^{x} mod p) (at 332) and obtaining Sp(=(Cp*r⁻¹) mod p) (at 333).

In another example embodiment of the present invention, the exponentiation using the prime number q (at 334, 335 and 336) may include computing Bq(=Aq^{dq′} mod q) (at 334), computing Cq(=Bq^{x} mod q) (at 335) and obtaining Sq(=(Cq*r⁻¹) mod q) (at 336).

In another example embodiment of the present invention, the third modular exponentiation algorithm 300 may further include applying the CRT where S′=CRT(Sp, Sq) (at 337).

In another example embodiment of the present invention, the error detection 340 may detect whether there is an error with the signature S which may be obtained by computing a modular operation S=(S\textcircled{+}Se\textcircled{+}M) mod n. If an error is generated, the error may be diffused throughout the signature S through the operation of the error detection 340.

In another example embodiment of the present invention, referring to FIGS. 2 and 3, the modular exponentiation algorithms 200/300 according to example embodiments of the present invention may be secure against the power attack because data may be changed at a higher rate and/or continuously during the execution of the modular exponentiation algorithms 200/300. Thus, an attacker may not be able to determine the algorithm through the limited exposed information. Further, when an error is generated, the error may be diffused throughout the signature S such that the attacker cannot extract information about the secret key.

The modular exponentiation algorithms according to example embodiments of the present invention may perform exponent masking as well as message masking in order to provide additional security against information attacks on the system. The operation overhead and/or processing requirements of the example modular exponentiation algorithms may not be increased significantly as compared to the conventional algorithms. The reduced operation overhead may be achieved because the public key may be smaller and/or random numbers used for masking may also include smaller sizes (e.g., approximately 30 bits, 60 bits, etc.). Accordingly, the modular exponentiation algorithms according to example embodiments of the present invention may be suitable for inclusion within a cryptosystem having a restricted memory size and/or limited processing capability (e.g., a smart card system).

Although described above primarily in terms of algorithms and processes, the example methodologies of the present invention may also be embodied in software as a computer program. For example, a program in accordance with the example embodiments of the present invention may be a computer program product causing a computer to execute one or more of the methods and/or processes.

The computer program product may include a computer-readable medium having computer program logic or code portions embodied thereon for enabling a processor of the apparatus to perform one or more functions in accordance with one or more of the example methodologies described above. The computer program logic may thus cause the processor to perform one or more of the example methodologies, or one or more functions of a given methodology described herein.

The computer-readable storage medium may be a built-in medium installed inside a computer main body or a removable medium arranged so that it can be separated from the computer main body. Examples of the built-in medium include, but are not limited to, rewriteable non-volatile memories, such as RAMs, ROMs, flash memories, and hard disks. Examples of a removable medium may include, but are not limited to, optical storage media such as CD-ROMs and DVDs; magneto-optical storage media such as MOs; magnetism storage media such as floppy disks (trademark), cassette tapes, and removable hard disks; media with a built-in rewriteable non-volatile memory such as memory cards; and media with a built-in ROM, such as ROM cassettes.

Further, such programs, when recorded on computer-readable storage media, may be readily stored and distributed. The storage medium, as it is read by a computer, may enable the processing of multimedia data signals prevention of copying these signals, allocation of multimedia data signals within an apparatus configured to process the signals, and/or the reduction of communication overhead in an apparatus configured to process multiple multimedia data signals, in accordance with the example methods described herein.

The example embodiments of the present invention being thus described, it will be obvious that the same may be varied in many ways. For example, while the above-described example embodiments of the present invention refer to first and second logic levels, it is understood that the first and second logic levels may refer to high and low logic levels, respectively, or low and high logic levels, respectively.

Further, while the above described masking and execution operations have been described as being performed in a given sequence or order of operation, it is understood that the operations in other example embodiments of the present invention may be performed in any order. Thus, while the appended claims refer to “first masking”, “second masking”, “third masking”, “fourth masking”, “first execution”, and “second execution”, or any other such numbered identifier, the claim terms are written as such to designate a distinct operation in a method, and not to designate an order of sequential operation.

Such variations are not to be regarded as departure from the spirit and scope of the example embodiments of the present invention, and all such modifications as would be obvious to one skilled in the art are intended to be included within the scope of the following claims.

What is claimed is:

1. A method of securing data, comprising:
message masking a message M using a number n and a random number r that is relatively prime to a number n;
exponent masking an exponent d using the number n and a random number x that is relatively prime to φ(n); and
executing a modular exponentiation based on data obtained from the message and exponent maskings.

2. The method of claim 1, wherein the number n satisfies the expression n=p*q, p and q being prime numbers.

3. The method of claim 1, wherein the exponent d satisfies the expression e*d=1 mod φ(n), wherein e is a number being relatively prime to φ(n)=(p−1)*(q−1).

4. The method of claim 1, further comprising:
generating a signature S satisfying S=M^{d} mod n including n and e as public keys and including d, p and q as secret keys.

5. The method of claim 1, wherein the message masking includes, generating a number t satisfying t=r^{e} mod n and generating a number A satisfying A=t*M mod n.

6. The method of claim 1, wherein the exponent masking includes generating a masked exponent d′ satisfying d′=d*x⁻¹ mod φ(n).

7. The method of claim 1, wherein the modular exponentiation includes obtaining a number B satisfying B=A^{d′} mod n, obtaining a number C satisfying C=B^{x} mod n and obtaining a signature S satisfying S=C*x⁻¹ mod n.

8. A method of securing data, comprising:
message masking a message M;
exponent masking exponents dp and dq;
first executing a modular exponentiation based on the first and second maskings;
detecting an error using modular exponentiation data obtained from the first execution;
second executing a modular multiplication operation based on the detection; and
diffusing the detected error to generate a first signature S.

9. The method of claim 8, wherein the message masking includes generating a random number r being relatively prime to a number n, masking the message M using r, e and p and masking the message M using r, e and q, wherein p and q are prime numbers and e is relatively prime to φ(n)(=(p−1)*(q−1)).

10. The method of claim 8, wherein the message masking includes generating a number tp satisfying tp=r^{e} mod p and generating a number Ap satisfying Ap=tp*M mod p.

11. The method of claim 8, wherein the message masking includes generating a number tq satisfying tq=r^{e} mod q and generating a number Bq satisfying Bq=tq*M mod q.

12. The method of claim 8, wherein the exponent masking includes generating an integer x that is relatively prime to φ(n), masking the exponent dp using the integer x and a prime number p and masking the exponent dq using the integer x and a prime number q.

13. The method of claim 12, further comprising:
generating a number dp′ satisfying dp′=dp*x⁻¹ mod (p−1).

14. The method of claim 12, further comprising:
generating a number dq′ satisfying dq′=dq*x⁻¹ mod (q−1).

15. The method of claim 8, wherein the first execution includes generating a number Bp satisfying Bp(=Ap^{dp′} mod p), a number Cp satisfying Cp(=Bp^{x} mod p), a number Bq satisfying Bq(=Aq^{dq′} mod q) and a number Cq satisfying Cq(=Bq^{x} mod q).

16. The method of claim 8, wherein the detection and diffusion include generating a first error variable using the prime number p, a second error variable using the prime number q and a diffusion variable of a detected error and applying a Chinese remainder theorem (CRT).

17. The modular exponentiation algorithm of claim 16, wherein the generation of the first error variable includes a generation of an error variable Dp satisfying Dp=Cp^{e} mod p and the generation of the second error variable includes a generation of an error variable Dq satisfying Dq=Cq^{e} mod q.

18. The method of claim 16, wherein the generation of the diffusion variable and applying the CRT includes generating a second signature S′ satisfying S′=CRT(Cp\textcircled{+}Aq\textcircled{+}Dq, Cq\textcircled{+}Ap\textcircled{+}Dp), where \textcircled{+} indicates an exclusive OR (XOR) operation.

19. The method of claim 8, wherein the modular multiplication operation obtains the first signature S satisfying S=(S*r⁻¹) mod n.

20. A method of securing data, comprising:
first masking a message M using numbers n, p, q, e and a random number r that is relatively prime to a number n, numbers n and p being prime numbers;
second masking exponents dp and dq using (p−1), (q−1), and the random number r that is relatively prime to φ(n);
executing a modular exponentiation based on data obtained by the message and exponent maskings;
detecting an error included in the output data of the modular exponentiation; and
generating a signature S including the detected error.

21. The method of claim 20, wherein the first masking includes at least one of third masking the message M using r, e and p and fourth masking the message M using r, e and q.

22. The method of claim 21, wherein the third masking includes computing a number tp satisfying tp=r^{e} mod p and a number Ap satisfying Ap=tp*M mod p.

23. The method of claim 21, wherein the fourth masking includes computing a number tq satisfying tq=r^{e} mod q and a number Bq satisfying Bq=tq*M mod q.

24. The method of claim 20, wherein the second masking includes generating an integer x that is relatively prime to φ(n), third masking the exponent dp using the integer x and the prime number p and fourth masking the exponent dq using the integer x and the prime number q.

25. The method of claim 24, wherein the third masking includes computing a number dp′ satisfying dp′=dp*x⁻¹ mod (p−1).

26. The method of claim 24, wherein the fourth masking includes computing dq′ satisfying dq′=dq*x⁻¹ mod (q−1).

27. The method of claim 20, wherein the execution includes a first exponentiation using the prime number p, a second exponentiation using the prime number q, and generating signature S satisfying S=CRT(Sp, Sq).

28. The method of claim 27, wherein the first exponentiation includes computing Bp satisfying Bp(=Ap^{dp′} mod p), computing Cp satisfying Cp(=Bp^{x} mod p) and obtaining Sp satisfying Sp=Cp*r⁻¹ mod p.

29. The method of claim 27, wherein the second exponentiation includes computing Bq satisfying Bq(=Aq^{dq′} mod q), computing Cq satisfying Cq(=Bq^{x} mod q) and obtaining Sq satisfying Sq=Cq*r⁻¹ mod q.

30. The method of claim 20, wherein the wherein the signature S satisfies S=S\textcircled{+}S^{e}\textcircled{+}M mod n, where \textcircled{+} denotes an exclusive OR (XOR) operation.

31. A method of securing data, comprising:
first masking a message;
second masking at least one exponent; and
first executing a modular exponentiation based on at least one of the first masking and the second masking.

32. The method of claim 31, further comprising:
detecting an error in the first execution.

33. The method of claim 32, further comprising:
diffusing the detected error to at least the first execution.

34. The method of claim 33, wherein the diffusion is applied to at least one of the first masking, the second masking, and the first execution.

35. The method of claim 33, further comprising:
second executing a modular multiplication.

36. The method of claim 33, wherein the diffusion is applied to at least one of the first masking, the second masking, the first execution, and the second execution.

37. A computer program product comprising a computer-readable medium having computer program logic stored thereon for enabling a processor to process data in an apparatus configured to receive the data, the computer program logic causing the processor to perform the functions of:
first masking a message;
second masking at least one exponent; and
first executing a modular exponentiation based on at least one of the first masking and the second masking.

38. The computer program product of claim 37, wherein the first masking includes using a number n and a random number r that is relatively prime to a number n and the second masking includes using the number n and a random number x that is relatively prime to φ(n).

39. The computer program product of claim 37, the computer program logic causing the processor to further perform the functions of:
detecting an error using modular exponentiation data obtained from the first execution;
second executing a modular multiplication operation based on the detection; and
diffusing the detected error to generate a first signature S.

40. The computer program product of claim 37, the computer program logic causing the processor to further perform the functions of:
detecting an error included in the output data of the first execution; and
generating a signature S including the detected error.

41. A system configured to provide a secure execution of data, comprising a processor to process data in an apparatus configured to receive the data, the processor configured to perform the functions of:
first masking a message;
second masking at least one exponent; and
first executing a modular exponentiation based on at least one of the first masking and the second masking.

42. The system of claim 41, wherein the first masking includes using a number n and a random number r that is relatively prime to a number n and the second masking includes using the number n and a random number x that is relatively prime to φ(n).

43. The system of claim 41, the processor configured to further perform the functions of:
detecting an error using modular exponentiation data obtained from the first execution;
second executing a modular multiplication operation based on the detection; and
diffusing the detected error to generate a first signature S.

44. The system of claim 41, the processor configured to further perform the functions of:
detecting an error included in the output data of the first execution; and
generating a signature S including the detected error.

45. A computer program product for performing the method of claim 31.

46. A system including a processor configured to perform the method of claim 31.
